(19) United States
(12) Patent Application Publication
(10) Pub. No.: US 2007/0240395 A9
(43) Pub. Date: Oct. 18, 2007

(54) Fastening element and arrangement

(75) Inventors: Wolfgang Kentner, Rofingen (DE); Karl-Friedrich Laible, Langenau (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munich (DE)

(21) Appl. No.: 11/037,650

(22) Filed: Jan. 18, 2005

Related U.S. Application Data
(63) Continuation of application No. PCT/EP03/07832, filed on Jul. 18, 2003.

(30) Foreign Application Priority Data
Jul. 22, 2002 (DE) 10233217.7

(51) Int. Cl. F21V 35/00; E06B 7/28; F16L 3/08; A47K 5/00; F21V 21/00; F16D 1/12; F24C 15/16; F16C 11/00; A47K 1/00; B01D 46/52; E04G 5/06; E04G 3/08; B01D 46/40; B01D 39/10; B01D 39/14; B01D 46/18; B01D 46/10; B01D 39/08; E04H 4/00; A47G 29/02; A47B 96/00; B01D 50/00; B01D 59/50; B01D 46/54

(52) U.S. Cl. 55/507; 248/239; 126/337 R; 403/141; 55/385.1; 248/222.52

(57) ABSTRACT

A fastening element for fastening an object to a wall, such as the wall of a refrigerator. The element has a head, a neck and a base successively arranged on a common axis. The element is located through a hole formed in the wall to secure the object to the wall. To accomplish this the neck has a circumference having a first radius and the base supports a collar having a second radius greater than the first radius. The element is secured to the object through the wall hole.

The present invention relates to a fastening element for fastening an object on a wall which is thin or does not have a high load-bearing capability, and to an arrangement in which such a fastening element is used.

The problem of having to fasten objects on such a wall arises, inter alia, in refrigerator construction. The housings of modern refrigerators are generally constructed from an outer wall made of sheet metal or plastic and an inner container which is thermoformed in one piece from a plastic blank, the outer wall and inner container bounding between them a cavity which is filled with thermally insulating foam material. Internals of such a refrigerator have to be fastened or supported on the inner container, this posing the problem of introducing the load of these internals into the basic housing structure, comprising the inner container, heat-insulation layer and outer cladding, such that the inner container is not overloaded and damaged as a result.

Telescopic pull-out means for article supports have to be fastened on such an inner container such that it is not possible for them to be accidentally pulled all the way out and, in the pulled-out state, to tip forward. This is possible, for example, by the telescopic pull-out means being screwed to the walls of the inner container with the aid of heat-insulation-side backing-parts. Since the entire load of the article supports on the screws has to be transmitted to the wall, the result is locally high loading. Overloading of the article supports may thus result in damage to the inner container which is difficult to repair cost-effectively.

In order to reduce the risk of damage to the inner container, suspension means for telescopic rails have been developed with the aim of distributing the loading to better effect over the wall of the inner container. Such suspension means have a multiplicity of parts and involve high outlay to install.

The object of the present invention is to provide a fastening element which makes it possible to support heavy loads on a wall with low load-bearing capability and which can be produced straightforwardly and inexpensively with a small number of parts and is quick to install.

The object is achieved by a fastening element having the features of claim 1.

The fastening element according to the invention can be installed by its head being plugged through a non-round aperture in the wall until the skirt butts against a first side of the wall, and then being rotated about its axis so that the protrusions of the head engage laterally beyond the aperture and butt against the second side of the wall. In this way, the wall is clamped in between the protrusions of the head on one side and the skirt on the other side. The larger the diameter of the head, i.e. the greater the spacing between the protrusions, the greater is also the maximum leverage to which the fastening element can be subjected before the wall is damaged.

The skirt is preferably elastic, with the result that, even in the case of differing wall thicknesses, the support can be fixed.

If the skirt completely covers the aperture, a sealing action is achieved at the same time. This is particularly advantageous if the wall is the inner container of a refrigerator since it is then possible, when the housing of the refrigerator is filled with foam, for the skirt to prevent the foam from passing through into the interior of the same.

A suspension means for the object which is to be fastened is preferably fitted on the head engaging through the aperture, i.e. the fastening element is installed from that side of the wall which is located opposite the side on which the object which is to be suspended is to be installed. This is also advantageous in the case of refrigerator construction since the fastening element can be installed from the more accessible outer side of the inner container.

The skirt of the fastening element may be formed integrally with the head. If the foot of the fastening element is formed in two parts from a core and a housing which covers over the core, the skirt may also be fitted on the housing, or both the core and the housing may have a skirt.

The core and the housing are preferably latched to one another. In this case, the core preferably has at least one latching arm which engages through an opening in a rear wall of the housing. In order to achieve satisfactory sealing of the opening in the latched state, a shoulder is preferably integrally formed on the latching arm, this shoulder blocking the opening in the latched state.

Telescopic rails for use in refrigerators usually have two fastening hooks on their rear side, a vertically oriented one for anchoring in a region of the side wall of an inner container which is in the vicinity of the door and a horizontal one for anchoring in a region of the side wall which is adjacent to the rear wall. In order for it to be possible to fasten such telescopic rails on the fastening arrangement according to the invention, the head of such a fastening element is preferably provided with an introduction opening for the introduction of such a hook.

The introduction opening of the head of the fastening element, in particular of the fastening element for the vertical hook, is expediently bounded laterally by a locking body which can be displaced elastically into the interior of the head. This locking body, upon introduction of the hook, is first of all forced back into the head, but springs back into its original position as soon as the hook has reached its target position, and thus prevents undesirable release of the hook from the head.

The locking body is preferably connected to the head by a hairpin-like spring, of which the two legs extend essentially parallel to the axis, i.e. perpendicularly to the wall in which the fastening element is installed. Such a spring can easily be formed integrally with the head and the locking body by injection molding.

Further features and advantages of the present invention can be gathered from the following description of exemplary embodiments with reference to the attached Figs., in which:

FIG. 1 shows a perspective view of an inner container of a refrigerator with telescopic rails secured on fastening elements according to the invention;

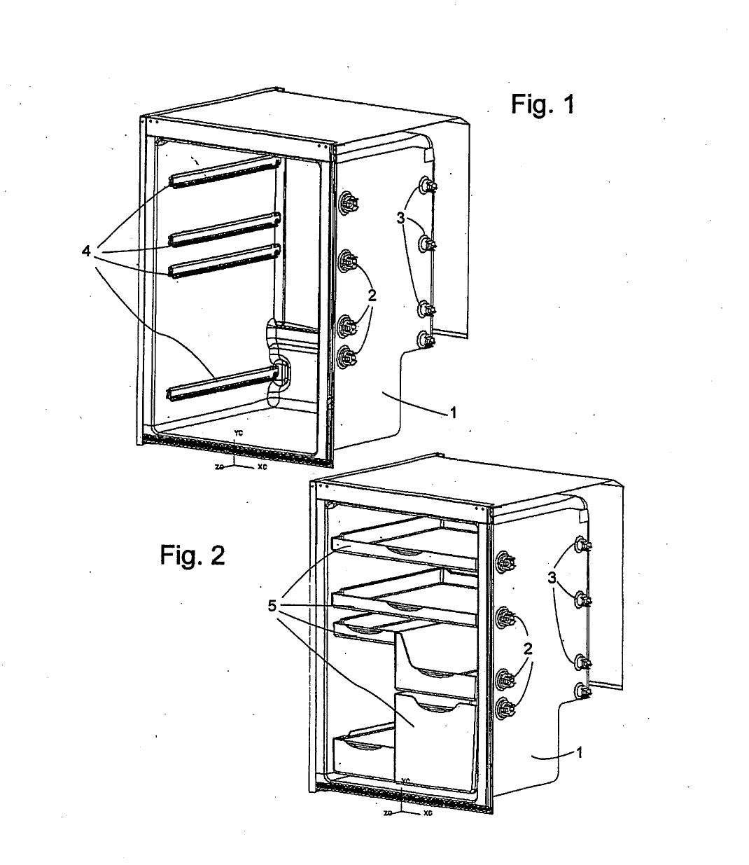

FIG. 2 shows a view of the inner container analogous to FIG. 1 with article supports installed on the telescopic rails;

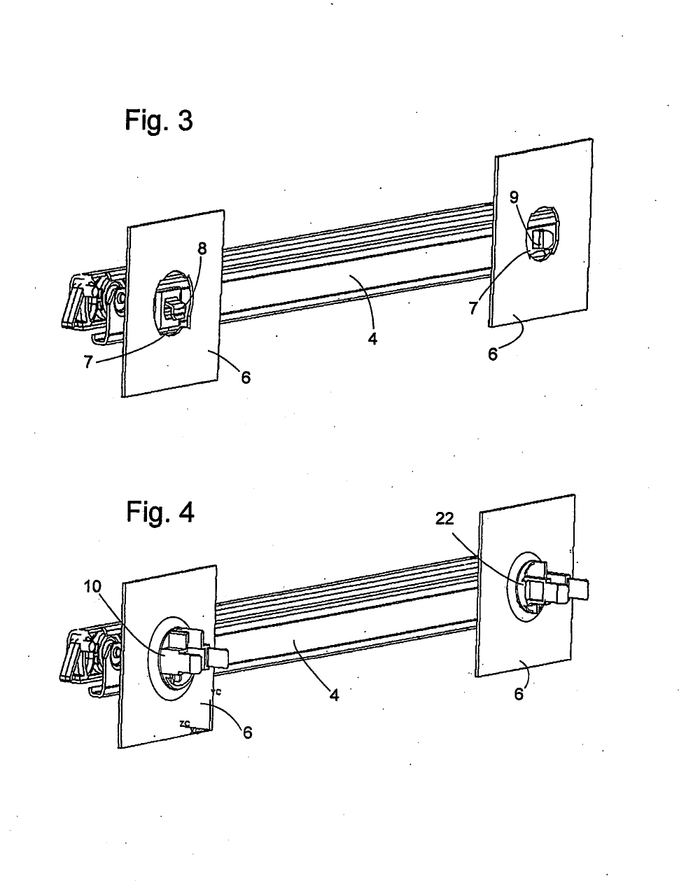

FIG. 3 shows a telescopic rail on a wall of the inner container with the fastening elements omitted;

FIG. 4 shows the same telescopic rail, this time together with the cores of two fastening elements;

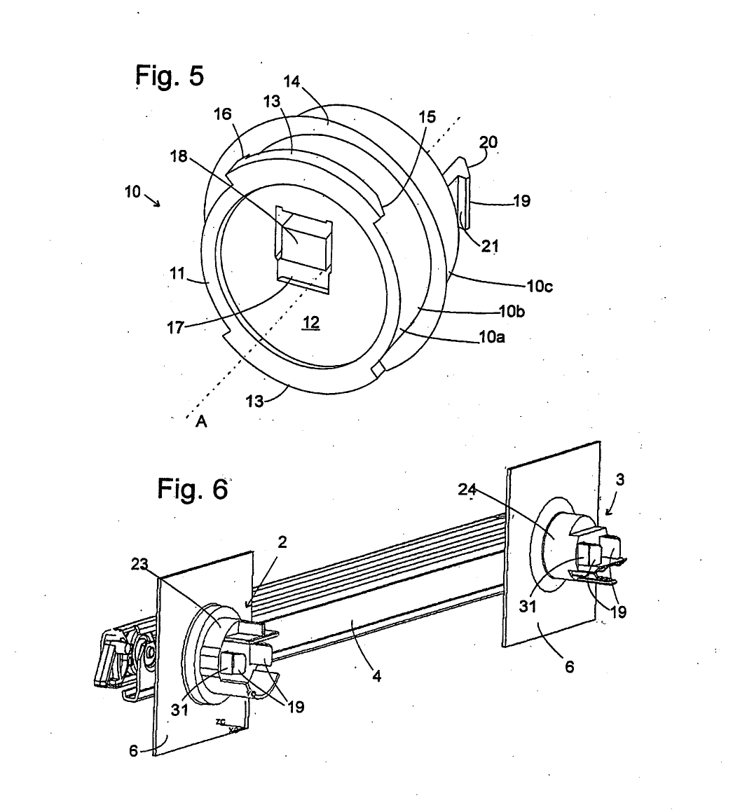

FIG. 5 shows a perspective view of part of a two-part fastening element;

FIG. 6 shows the same telescopic rail as in FIGS. 3 and 4, this time with housings installed on the fastening arrangements;

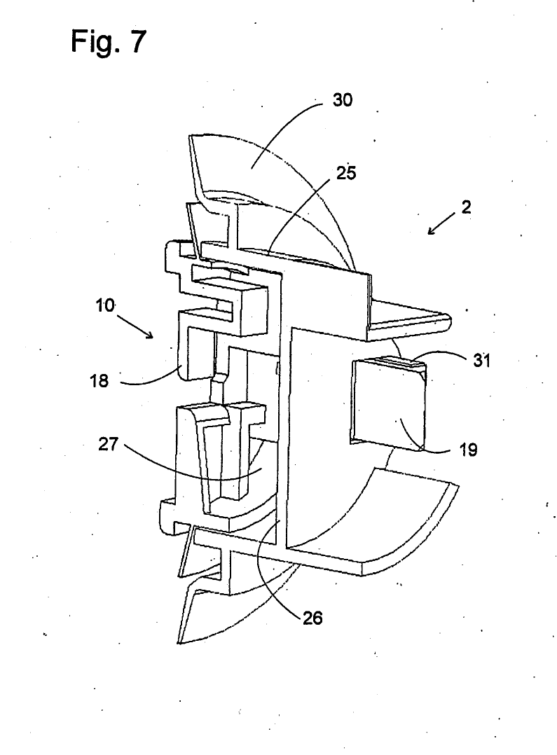

FIG. 7 shows a perspective illustration, in section, of the front fastening element from FIG. 6 without a wall or telescopic rail;

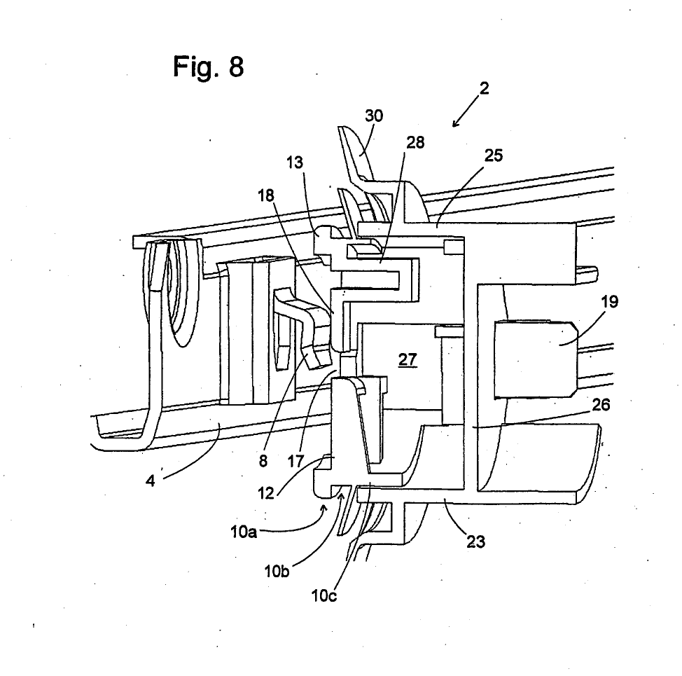

FIG. 8 shows the fastening element from FIG. 7 with telescopic rail positioned in front of it;

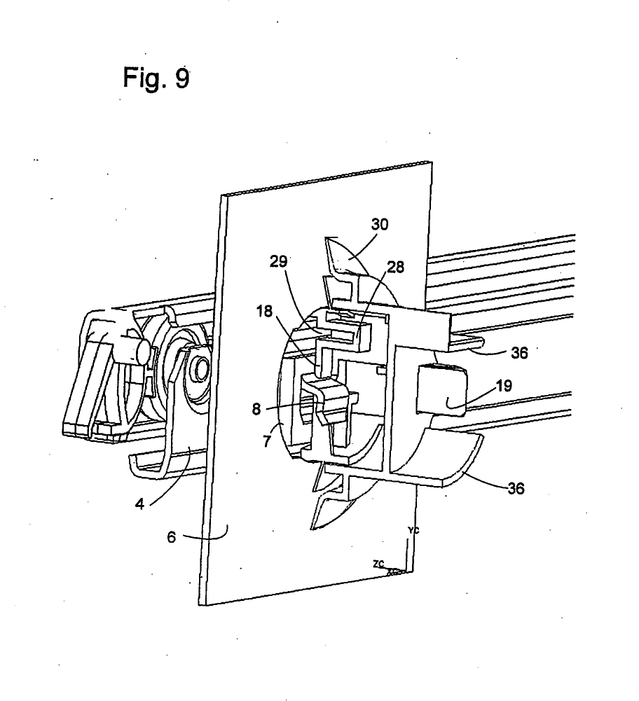

FIG. 9 shows the fastening element in engagement with the telescopic rail;

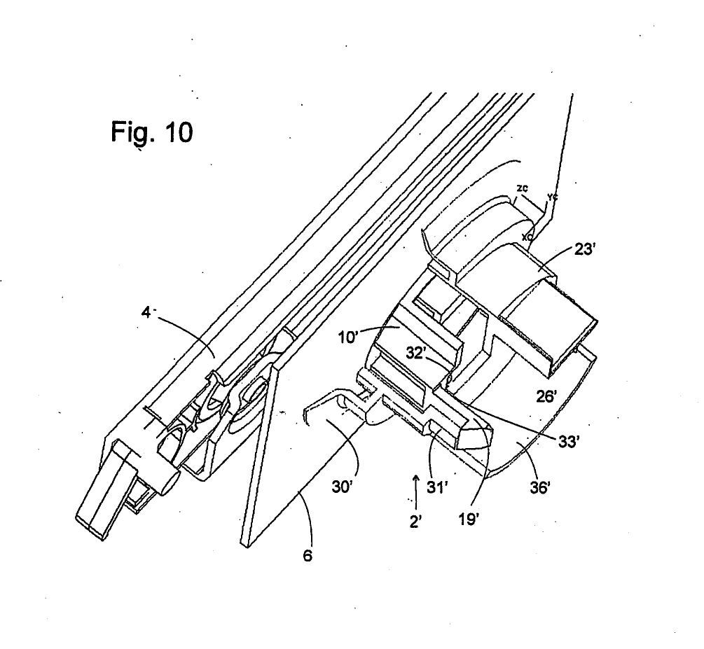

FIG. 10 shows a further illustration, partly in section, of the fastening element from FIG. 7;

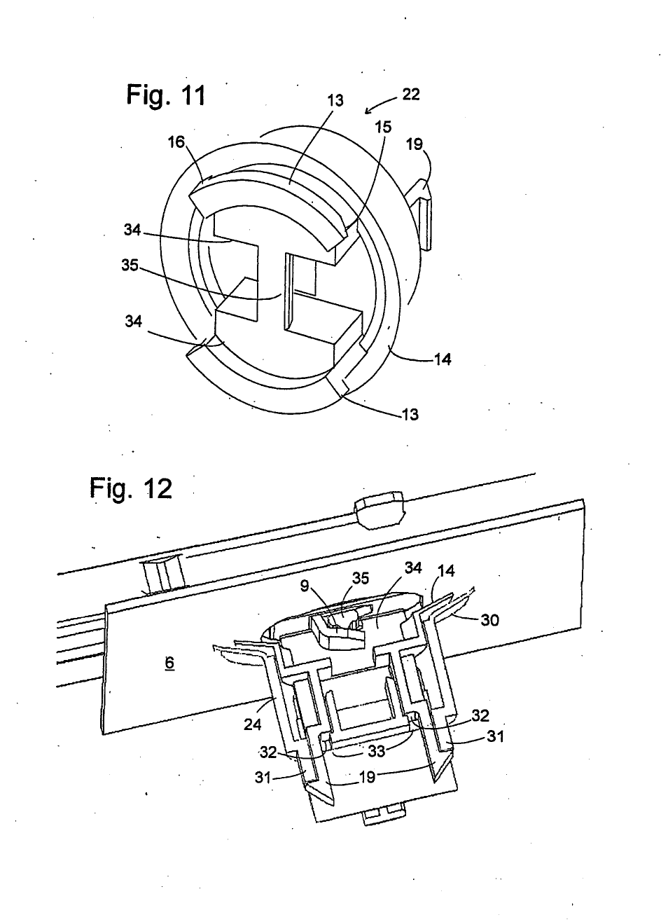

FIG. 11 shows a perspective view of part of the rear fastening element from FIG. 6;

FIG. 12 shows a perspective view, in section, of the rear fastening element from FIG. 6;

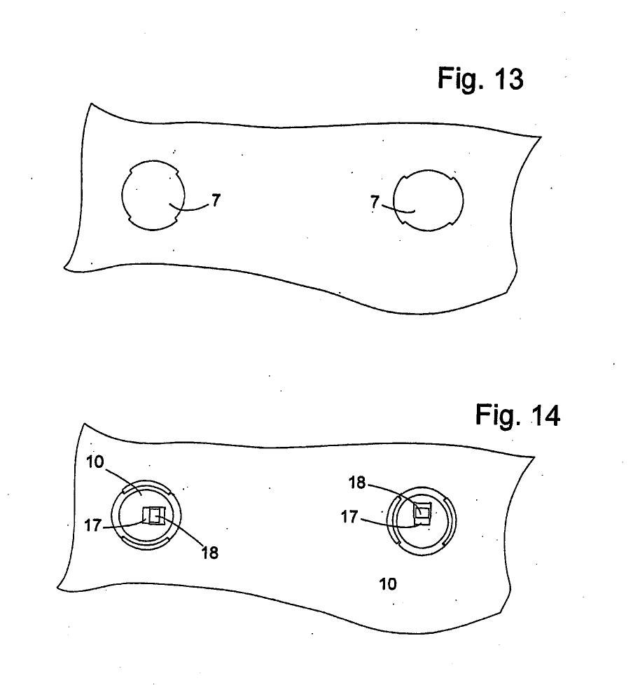

FIG. 13 shows a plan view of a portion of a wall with two apertures; and

FIG. 14 shows a plan view of the portion of the wall with fastening elements installed in the apertures.

FIG. 1 shows a perspective view of parts of an inner container 1 of a refrigerator in which the fastening element according to the invention is used. Front and rear fastening elements 2, 3 are fitted at different heights, in pairs in each case, on the side walls of the inner container 1 and each bear a telescopic rail 4 in twos. On that side wall of the inner container 1 which is directed toward the observer, it is possible to see in each case only the outer feet of the fastening elements 2, 3, but not the telescopic rails which are retained by them, and are concealed by the wall; on the side wall which is directed way from the observer, it is possible to see only the telescopic rails 4, but not the fastening elements thereof. The telescopic rails 4 serve for securing pull-out article supports 5, as is shown in FIG. 2.

FIG. 3 shows, in the perspective of FIGS. 1 and 2, a telescopic rail 4 on the side wall 6 of the inner container 1 which is directed toward the observer, the side wall 6 in the illustration having been reduced to two portions in order for it to be possible to show the telescopic rail. These portions each have an aperture 7 level with fastening hooks 8, 9 of the telescopic rail 4. The front fastening hook 8 is directed downward, and the rear fastening hook 9 is directed toward the rear wall of the inner container 1. The cross-sectional shape of the apertures 7 is made up of four concentric circle segments, mutually opposite circle segments each having the same radius and adjacent circle segments having different radii.

A first part 10 of the fastening element 2, referred to hereinbelow as the inner part, which is provided for fitting in the aperture 7 which is located at the front in FIG. 3 is shown in FIG. 5. The inner part 10 has a cup-like body with a cylindrical outer wall 11 and an end wall 12 which, with the core 10 in the installed state, is directed toward the interior of the inner container 1. The radius of the cylindrical outer wall 11 corresponds to the smaller of the two radii of the aperture 7. The inner part 10 is divided up, in the direction to the axis, into three portions: a head 10a, which is directed toward the observer, a neck 10b and a core 10c, which are provided in order, with the inner part installed on the inside of the side wall 6, to be located in the side wall 6 or on the outside thereof.

The head 10a, level with the end wall 12, bears, on its cylindrical circumference, two crosspiece-like protrusions 13 projecting radially from the outer wall 11. The protrusions 13 have an outer contour in the form of a circle arc, the radius of the outer contour corresponding to the larger of the two radii of the aperture 7, with the result that the head 10a can be plugged through the aperture 7 in an orientation in which it is rotated through 90° in relation to the orientation shown in FIG. 5.

The core 10c bears a conical skirt 14 extending around the outer wall 11. The base of the cone is directed toward the protrusions 13. The skirt 14 is thin-walled, with the result that, in contrast to the outer wall 11 and the protrusions 13, it can be elastically deformed to a certain extent. The spacing between the protrusions 13 and the skirt 14, i.e. the length of the neck 10b, is slightly smaller than the thickness of the wall 6, with the result that, when the head 10a is plugged through the aperture 7, the skirt 14 has to be pressed flat elastically before the protrusions 13 reach the inside of the wall 6 and, by rotation of the head 10a, can be brought into engagement thereon.

In order to make it easier for the head 10a to be guided through counter to the resilient force of the skirt 14, it is possible, as is shown in FIG. 5, for the protrusions 13 to be provided with a bevel 15 at one end in each case. A thickening 16 at the other end of the protrusions 13, this thickening being directed toward the skirt 14, forms a stop which defines the orientation of the inner part 10 once it has been screwed into the wall 6.

The end wall 12 contains an accommodating opening 17 which is provided in order to latch the front fastening hook 8 of the telescopic rail 4 therein. The accommodating opening 17 is only free in its bottom region, a top region being occupied by a locking body 18, the function of which will be explained at a later stage in the text.

Two latching arms 19 are integrally formed on the rear side of the core 10c, only one of these latching arms being visible in FIG. 5. The latching arms 19 have latching hooks with mutually remote sloping surfaces 20 and hook-end surfaces 21.

FIG. 4 shows the inner part 10 and a similarly constructed inner part 22 of the rear fastening element 3, each in a position in which they are installed on the wall 6.

In FIG. 6, the two fastening parts 2, 3 have been completed in each case by virtue of a respective housing 23, 24 being plugged onto the latching arms 19.

The structure of the housing and its connection to the core are illustrated by way of example in FIG. 7 with reference to the front fastening element 2. FIG. 7 shows the front fastening element 2 in section along its center plane, the wall 6 having been omitted.

The housing 23, like the core 10 has a cylindrical outer wall 25 which, with a rear wall 26, forms a cup shape. The cylindrical outer wall 25 of the housing 23, rather than being supported directly on the side wall 6 (not illustrated), terminates at the root of the skirt 14 of the core 10. In order for the housing 23 likewise to be supported on the side wall 6, an encircling conical, elastic skirt 30 is, in turn, integrally formed on the outer wall 25, the large base surface of this skirt butting against the side wall 6. The two skirts 14, 30 thus ensure an elastic and liquid-tight clamping action of the fastening element 2 on the wall 6 which is tolerant to fluctuations in the thickness of the wall 6 and moreover, as can be seen in FIG. 9 in particular, reliably prevents insulating foam which is processed in liquid starting components from passing through into the interior of the fastening element 2 along the wall 6.

The cups of the core 10 and housing 23, which are plugged one inside the other in each case with their open sides in the front, enclose a cavity 27. This cavity 27 is provided in order to accommodate the front fastening hook 8 of the telescopic rail 4.

FIG. 8 shows the fastening element 2 and the telescopic rail 4 in a position immediately prior to being fitted on the fastening element 2. An essentially vertically downwardly running end portion of the fastening hook 8 is located opposite the locking body 18 of the head 10a. The vertical portion of the hook 8 is higher than the open cross-sectional surface area of the accommodating opening 17. In order to introduce the hook 8 into the accommodating opening 17, the locking body 18 thus has to be forced back into the interior of the cavity 27. This is possible since the locking body 18 is connected elastically, rather than rigidly, to the core 10 via a hairpin-like spring 28. The hook 8 can thus be introduced far enough into the cavity 27, counter to the restoring force of the spring 28, in order then to engage behind the end wall 12 in a downward movement. As a result of this downward movement, the locking body 18 is freed and returns into its rest position, in which it is flush with the end wall 12.

The result is shown in FIG. 9.

In order for the hook 8 to be released again from the position shown in FIG. 9, it would have to be moved upward, although the locking body 18 only allows this to the extent for the gap 29 between the two legs of the hairpin-like spring 28 is thus closed. This displacement, however, is not sufficient in order to release the hook 8 from the end wall 12. The situation where the hook 8 is freed accidentally is thus ruled out. If required, however, it is nevertheless possible for the telescopic rail 4 to be removed by, first of all, the locking body 18 being forced back with the aid of a pointed implement, for example a screwdriver, which can be introduced into the aperture in an oblique direction from above between the wall 6 and the telescopic rail 4.

The rear wall 26 of the housing 23 contains two openings 33 for the through-passage of the latching arms 19. The openings are bounded at a border in each case by crosspieces 31 (see FIG. 6) which project from the rear wall 26 and on the rear edge of which in each case the hook-end surfaces 21 of the latching arms 19 act. In order to prevent foam from passing through the openings 33 as well, the latching arms 19 are each provided with a shoulder (concealed in the figure) which butts against the inside of the rear wall 26 and blocks the opening 33. Wings 36 projecting from the rear wall 26 provide additional hold for the housing 23 when they are enclosed by insulating foam once the refrigerator has been assembled.

FIG. 10 shows a modified configuration of a front fastening element 2′ on the wall 6, a quarter of the housing 23′ of the fastening element having been cut away in order to render the inner part 10′ visible. This illustration clearly shows the shoulder 32′, which butts against the rear wall 26′ of the housing 23′ and blocks the free cross section of the opening 33′ in the rear wall.

The significant difference between this configuration and that described above is that, in this case, there is no skirt on the inner part 10′. The fastening element is retained merely by the clamping force between the skirt 30′ of the housing 23′ and the protrusions on the head of the inner part 10′ (these protrusions not being visible in the figure).

The protrusions of the inner part 10′ may be configured in the same way as those shown in FIG. 5. On account of the skirt being omitted, however, it is also possible for the core 10′ to be introduced into the aperture 7 from the inside of the wall 6. It is thus also possible, in the case of this configuration, for the protrusions to be fused to form an encircling crosspiece which completely covers over the aperture 7 on the inside of the wall 6. Since the inner part 10′ is not anchored by rotation in the aperture 7, it and the aperture 7 may have largely any desired, preferably non-circular cross sections.

FIG. 11 shows a perspective view of the inner part 22 of the rear fastening element 3 as seen from the inside. The cylindrical outer wall here has been reduced, in its front region, to two strong arms 34 bearing protrusions 13. A vertical bar 35 extends between the arms 34 and is provided in order to have the rear fastening hook 9 of the telescopic rail 4 engaging around it. There is no locking means for the hook 9 on the rear fastening element. This is not necessary since it is only possible for the rear fastening hook 9 to be freed from the fastening element 3 if the front hook 8 is released from its fastening element. It is thus sufficient just to unlock the front hook 8, in order for it to be possible to remove the telescopic rail 4.

FIG. 12 shows the same fastening element 3 in a perspective view from above, in section along a horizontal center plane. It is possible to see the fastening hook 9 engaging behind the bar 35, and also the latching arms 19 latched to crosspieces 31 of the housing 24. Here too, the openings 33 of the housing through which the latching arms 19 engage are blocked by an internally abutting shoulder 32 at the base of the latching arms 19.

FIG. 13 shows part of a side wall 6 of a refrigerator according to a further modification of the invention. The Fig. illustrates two apertures 7 in this side wall 6, these each having the same cross-sectional surface area as the apertures 7 in FIG. 3, the single difference being that the outline of the aperture which is provided for accommodating a rear fastening element, i.e. of the left-hand aperture 7 in FIG. 13, has been rotated through 90° in relation to the right-hand aperture 7. This makes it possible for the inner part 10 which is shown in FIG. 5 and the associated housing 23, which is shown in FIG. 6, to be installed in the two apertures 7 in orientations which are rotated through 90° in each case, as is shown in FIG. 14. Only a single type of fastening element is thus required in order to accommodate both hooks 8 and 9 of the telescopic rail 4.

1-18. (canceled)

19. A fastening element for fastening an object on a wall, comprising:
a fastening element body including a head, a neck and a foot arranged successively on an axis;
said neck including a periphery having a first radius;
said foot including at least a first skirt which projects beyond a periphery of said foot and having a second radius greater than said first radius; and
said head including lateral protrusions which bear over a portion of a periphery and which project beyond said first radius.

20. The fastening element according to claim 19, including said skirt is formed from elastic material.

21. The fastening element according to claim 19, including suspension means formed on said head for the object to be fastened to the wall.

22. The fastening element according to claim 19, including said first skirt is integrally connected to said head.

23. The fastening element according to claim 22, including a second skirt which encloses said first skirt.

24. The fastening element according to claim 19, including said foot constructed in at least two parts, one a core and a second a housing which covers said core.

25. The fastening element according to claim 24, including said housing includes a second skirt.

26. The fastening element according to claim 24, including said core and said housing releaseably connected to one another.

27. The fastening element according to claim 26, including said core including at least one latching element having a shoulder thereon, said housing including a rear wall with an opening therethrough and said latching element engaged through said opening with said shoulder blocking said opening when said latching element is engaged therethrough.

28. The fastening element according to claim 19, including the object having a protrusion and said head having an introduction opening for introduction of said protrusion therethrough.

29. The fastening element according to claim 28, including said introduction opening having a locking body which can be displaced elastically into an interior of said fastening element body.

30. The fastening element according to claim 29, including said locking body having a hairpin-like spring and said locking body connected to said fastening element body head by said hairpin-like spring.

31. A fastening arrangement for fastening an object on a wall, comprising:
a wall including an aperture therein;
a fastening element including a head, a neck and a foot arranged successively on an axis;
said neck including a periphery having a first radius;
said foot including at least a first skirt which projects beyond a periphery of said foot and having a second radius greater than said first radius;
said head including lateral protrusions which bear over a portion of a periphery and which project beyond said first radius;
said fastening element inserted through said aperture with said foot located on a first side of said wall and said head located on a second side of said wall;
said first skirt butting against said first side of said wall; and
said head rotatable between a first orientation in which it can be inserted through said aperture and a second orientation in which said protrusions on said head engage laterally beyond said aperture and butt against said second side of said wall.

32. The arrangement according to claim 31, including said skirt completely covers said aperture.

33. The arrangement according to claim 31, including said aperture having a border made up of concentric circle-arc portions with two different alternating radii.

34. The arrangement according to claim 31, including said wall is a part of an inner container of a refrigerator.

35. The arrangement according to claim 34, including the object is a pull-out rail to be fastened to said inner container wall.

36. The arrangement according to claim 35, including said pull-out rail having a substantially vertical hook and a substantially horizontal hook spaced from one another, and a first said head having an introduction opening and said vertical hook engages in said introduction opening and a second head and said horizontal hook engages in said second head without locking means.

37. A refrigerator, comprising:
an inner container having at least one inner wall;
said inner wall including at least a pair of apertures therein;
at least a pair of fastening elemenst for fastening a pull-out rail to said inner container wall, said fastening elements each including a head, a neck and a foot arranged successively on an axis;
said neck including a periphery having a first radius;
said foot including at least a first skirt which projects beyond a periphery of said foot and having a second radius greater than said first radius;
said head including lateral protrusions which bear over a portion of a periphery and which project beyond said first radius;
each said fastening element inserted through one of said apertures with said foot located on a first side of said wall and said head located on a second side of said wall;
said first skirt butting against said first side of said wall; and
said head rotatable between a first orientation in which it can be inserted through said aperture and a second orientation in which said protrusions on said head engage laterally beyond said aperture and butt against said second side of said wall.

38. The arrangement according to claim 37, including said skirt completely covers said aperture and including said foot constructed in at least two parts, one a core and a second a housing which covers said core and said core and said housing releaseably connected to one another.
